(19) United States
(12) Patent Application Publication
(10) Pub. No.: US 2007/0191212 A1
(43) Pub. Date: Aug. 16, 2007

(54) Supported catalyst with a defined pore distribution in the mesopore range

(75) Inventors: Markus Schubert, Ludwigshafen (DE); Jurgen Stephan, Mannheim (DE); Volker Bohm, Frankenthal (DE); Andreas Brodhagen, Ludwigshafen (DE); Frank Poplow, Ludwigshafen (DE); Christian Weichert, Durkheim (DE); Holger Borchert, Offstein (DE)

Correspondence Address: CONNOLLY BOVE LODGE & HUTZ, LLP, P O BOX 2207, WILMINGTON, DE, 19899, US

(73) Assignee: Basf Aktiengesellschaft, Ludwigshafen (DE)

(21) Appl. No.: 10/590,978

(22) PCT Filed: Feb. 24, 2005
(86) PCT No.: PCT/EP05/01912

§ 371 Date: Aug. 28, 2006

(30) Foreign Application Priority Data
Feb. 28, 2004 (DE) 102004009805.0

(51) Int. Cl. B01J 35/08

(52) U.S. Cl. 502/8; 502/102; 502/104; 502/105; 502/300

(57) ABSTRACT

Supported catalyst comprising a support (S) in which Al₂O₃ is present in a proportion of at least 75% by weight and rhenium compounds as active component (A), wherein the maximum of the distribution function of the pore diameters in the mesopore range is at from 0.008 to 0.050 μm.

The present invention relates to a supported catalyst, processes for producing it and processes for the metathesis of nonaromatic unsaturated hydrocarbon compounds using the supported catalyst.

It is generally known that the pore structure of supported catalysts is of critical importance for their activity. This is particularly true of supported catalysts which are used for the metathesis of nonaromatic unsaturated hydrocarbon compounds.

The metathesis of nonaromatic unsaturated hydrocarbon compounds is a long-established method of breaking and reforming C—C bonds (e.g. Mol, J. C., Chapt. 4.12.2 “Alkene Metathesis” in “Handbook of Heterogeneous Catalysis”, Eds. Ertl, G., Knözinger, H., Weitkamp, J., VCH, Weinheim 1997; Weissermehl, K., Arpe, H.-J., Chapt. 3.4 “Olefin-Metathese” in “Industrielle Organische Chemie”, 4th Edition., VCH, Weinheim 1994). Various types of catalysts for a heterogeneously catalyzed metathesis have been described. For the temperature range up to about 120° C., the use of supported Re₂O₇ or Re(CO)₁₀ catalysts is customary (Mol, J. C., Chapt. 4.12.2 “Alkene Metathesis” in “Handbook of Heterogeneous Catalysis”, Eds. Ertl, G., Knözinger, H., Weitkamp, J., VCH, Weinheim 1997).

DE-C-3823891 and EP-A-90994 disclose the preparation of an aluminum oxide which has a maximum of the distribution function of the pore diameters in the mesopore range at above 0.008 μm. Apart from numerous other applications, the general use as support material for catalysts is mentioned.

Re-containing catalysts in which no attention is paid to the pore structure are described, for example, in U.S. Pat. Nos. 3,641,189 and 3,642,931. However, these catalysts deactivate rapidly, which makes frequent regeneration necessary. A slurry of the deactivation makes industrial implementation considerably easier. In addition, a high activity is desirable in order to utilize the noble metal used as effectively as possible.

It was an object of the present invention to provide porous supported catalysts which have a specific pore structure and maintain a high activity over a very long period of use. In particular, catalysts which are suitable for the preparation of nonaromatic unsaturated hydrocarbon compounds by metathesis are to be provided.

We have accordingly found a supported catalyst comprising a support (S) in which Al₂O₃ is present in a proportion of at least 75% by weight and a rhenium compound as active component (A), wherein the maximum of the distribution function of the pore diameters in the mesopore range is at from 0.008 to 0.050 μm.

The support material (support S) for producing the supported catalysts comprises at least 75% by weight of gamma-Al₂O₃. Depending on the calcination temperature, amounts of other phases such as alpha-, eta-, delta- or theta-Al₂O₃ can also be present. The ratio of the various phases to one another is not critical, although the proportion of alpha-Al₂O₃ is preferably kept as low as possible (preferably less than 10%). For the purposes of the present invention, calcination is heating in an oxidative gas atmosphere, e.g. a gas atmosphere comprising more than 20% by volume of oxygen and otherwise inert constituents. The preferred gas atmosphere is air.

In one variant of the production process, the catalysts having the desired pore structure are obtainable by using supports (S) having a maximum of the distribution function of the pore diameters in the mesopore range at from 0.008 to 0.050 μm in the production process and the catalyst is produced by customary methods from these supports (S) and an active component (A) using customary auxiliaries if appropriate.

To produce such supports (S) having a maximum of the distribution function of the pore diameters in the mesopore range at from 0.008 to 0.050 μm, a particularly useful process is one in which aluminum alkoxides occur as intermediate. The synthetic aluminum oxide precursors produced by such a route allow the mesopore size to be set in the specified range. According to DIN 66 134 of February 1998, published by the Deutsche Institut für Normung e.V., mesopores are pores having sizes from 2 to 50 nm.

In this specific process, an aluminum alkoxide is aged at a water vapor pressure of from 1 to 30 bar and a temperature of from 100 to 235° C. for from 0.5 to 20 hours while stirring at a circumferential velocity of from 1.0 to 6.0 m/s to form a synthetic aluminum hydroxide. This is then usually dried by a customary method. This process and further details regarding it are known from DE-C-3823895.

In many cases, the supports (S) can be in the form of spherical shaped bodies. These can be obtained particularly advantageously by
preparing an alumina sol from a synthetic aluminum hydroxide prepared as described above by suspending the synthetic aluminum hydroxide in dilute mineral acid having a concentration of from 1 to 5% and subsequently adding from 1 to 10% by weight, based on the total weight of the sol, of urea,
introducing the alumina sol dropwise into a shaping column whose lower part is filled with aqueous ammonia solution, and
drying the spherical particles formed in the shaping column.

The alumina hydrate used here is preferably obtained by hydrolysis of an aluminum alkoxide. This preparative process and further details regarding it are known from EP-A-90994.

Apart from aluminum oxide, the support (S) may, if appropriate, further comprise additional customary support materials, preferably materials selected from the group consisting of SiO₂, aluminosilicates, TiO₂, ZrO₂, MgO, CeO₂ and ZnO.

To improve the physical properties of the catalyst, further lubricants and additives in addition to the actual support material can also be mixed in, e.g. graphite, cement, gypsum or muscovite.

Suitable supports (S) typically have a specific surface area of less than 280 m²/g, preferably from 70 to 250 m²/g, particularly preferably 100-200 m²/g. Suitable pore volumes (determined by means of mercury porosimetry) are usually in the range from 0.25 to 1.3 ml/g, preferably from 0.35 to 1.0 ml/g. The preferred water absorption is from 0.4 to 1.5 ml/g. The determination of the pore size and volume and their distribution is carried out in accordance with DIN 66134 of February 1998 and DIN 66133 of 1993, published by the Deutsche Institut für Normung e.V.

If appropriate, the support can additionally have been treated with acids.

The active component (A) applied to the support (S) comprises at least one compound of rhenium. Suitable compounds include the sulfides, oxides, nitrides, carbonyls, halides and acids. Particular preference is given to ammonium perrhenate or perrhenic acid and rhenium heptoxide. The rhenium component can be applied to the support material by all customary methods, preferably to the finished shaped support bodies. These include, for example, methods such as impregnation in an excess of solution, “dried impregnation” (i.e. calculated according to the particular water absorption), sublimation (especially for carbonyls). If necessary, water is preferably used as solvent for the rhenium component, but it is also possible to use organic solvents such as alcohols or dioxane. In addition to the rhenium component, the active component (A) can further comprise a promoter, i.e. one or more further compounds which optimize the activity or selectivity of the finished catalyst. These compounds are selected from the group consisting of phosphorus oxide, Fe₂O₃, tantalum oxide, ZrO₂, SiO₂ niobium oxide, molybdenum and tungsten compounds, oxides of the elements of the lanthanide series, vanadium oxide, alkali metal, alkaline earth metal, lead and tin compounds. These compounds can be applied before, after or simultaneously with the rhenium component.

The proportion of active component (A) in the supported catalyst is usually from 0.1 to 30% by weight. As active component, preference is given to rhenium oxide in an amount of from 0.5 to 15% by weight. The rhenium oxide is particularly preferably present in crystallites smaller than 1 nm on the surface. This corresponds to rhenium surface areas (determined by means of N₂O chemisorption) of greater than 0.4 m²/g, as described in DE 19,837,203 for coated catalysts.

In the supported catalyst of the invention, the total pore volume measured by means of mercury porosimetry in the range from 300 to 0.003 μm is generally greater than 0.2 ml/g, preferably 0.3 ml/g, particularly preferably 0.5 ml/g, and the sum of the surface areas of these pores is greater than 30 m²/g, preferably greater than 130 m²/g, but less than 250 m²/g. The determination of the pore size and volume and their distribution is carried out in accordance with DIN 66133 of June 1993 and DIN 66134 of February 1998, published by the Deutsche Institut für Normung e.V.

The production of the catalyst of the invention can be carried out in three different ways.

The first method has already been mentioned above in the description of suitable supports (S). Here, the supports (S) having a maximum of the distribution function of the pore diameter in the mesopore range at from 0.008 to 0.050 μm are used and the supported catalysts are otherwise produced by customary methods.

The second method comprises
a1) in step (a1), producing a raw mixture (a) comprising a finely divided support (S) onto which a customary active component may have been applied if appropriate, a pore-forming material (P), customary auxiliaries and if appropriate a customary active component,
b1) in step (b1), forming shaped bodies as are customary for supported catalysts from the raw mixture (a) and, either simultaneously or in a subsequent separate procedure, removing the pore-forming material (P) by heating,
c1) in step (c1), if appropriate applying an active component (A) to the shaped bodies, with the step (c1) being obligatory if the production of the raw mixture (a) in step (a1) has been carried out without using the active component (A) or a support (S) to which an active component (A) has already been applied and otherwise being optional.

The abovementioned sequence of steps encompasses the embodiments: (i) the total amount of the active component (A) is used in the raw mixture (a) in step (a1), either as a result of it being added separately to the raw mixture (a) or as a result of it having previously been applied to the customary support (S), (ii) only part of the total amount of the active component (A) is used in the raw mixture (a) in step (a1), (iii) the active component (A) is not yet used in the raw mixture (a) in step (a1). In the case of embodiment (i), step (c1) is unmeasured. In the case of embodiment (ii), it is necessary to add the missing part of the active component by means of step (c1). In the case of embodiment (iii), it is necessary to use the total amount of the active component (A) in step (c1).

In the finely divided supports (S) used in this second method, the mean particle size is generally from 30 to 120 μm, with preference being given to 30% by weight of the particles having a particle size of more than 60 μm. The particle size is determined by conventional methods, e.g. sieve analysis.

Preferred pore-forming materials (P) are inorganic or organic compounds which decompose at temperatures below 500° C., preferably below 450° C., and leave no residues in the catalyst. Suitable pore-forming inorganic materials are, for example, carbonates, hydrogencarbonates or oxalates, in particular as ammonium salts. Suitable organic pore formers are tartaric acid, oxalic acid, citric acid, ammonium nitrate, ammonium oxalate, guanidinium salts, urotropin, proteins such as gelatin, hydrocarbons such as glucose, sucrose and soluble starch, polytetrahydrofuran, surfactants, sulfonic acids, polyvinyl alcohol, methylcellulose, polyalcohols, lactic acid, polyethylene oxides, polymethylene oxides, polypropylene oxides, polyolefins, nut shell powders, polyacrylates, carbonates, hydrogencarbonates, fats, waxes, fatty acids, alginates, textile fibers, plant fibers and oxalates. The term polyalcohols encompasses sugars, starches, flour, celluloses and cellulose derivatives. The term plant fibers also encompasses paper pulp. The pore formers used usually have mean particle sizes of more than 10 nm, preferably more than 100 nm, particularly preferably more than 1 μm. The particle size is determined by conventional methods, e.g. sieve analysis.

The process for producing the catalysts of the invention can vary:

In one embodiment, the raw mixture (a) is prepared as a powder mixture by mechanical mixing of the starting materials and the shaped bodies are produced by pressing the powder mixture. It is also possible to add further auxiliaries and additives which serve to improve the processability of the catalyst or have a favorable effect on the physical properties of the catalyst, e.g. graphite, cement, copper powder.

In a further embodiment, the raw mixture (a) is prepared as an extrudable suspension in which the support (S) and the pore former (P) form a discontinuous phase and a customary suspension medium forms the continuous phase and the active component (A), if present, is dissolved or suspended in the continuous phase. Suitable suspension media are mineral acids, water or C₁-C₄-carboxylic acids, e.g. nitric acid, acetic acid or formic acid. The suspension is usually produced from the abovementioned starting materials by means of kneading or, preferably, pan milling processes.

The extrudable suspension is usually converted into a moldable supported catalyst precursor by shaping the extrudable suspension to form shaped bodies as are customary for supported catalysts and subsequently curing the shaped bodies by evaporating the suspension medium in a customary fashion. This generally occurs at temperatures of from 50 to 200° C.

To remove the pore former (P), the shaped bodies are generally heated in an oxygen-containing atmosphere at a temperature of from 250 to 1100° C., preferably from 300 to 850° C.

If the removal of the pore former (P) is carried out at temperatures lower than 500° C., the shaped body obtained in this way is subsequently calcined at temperatures of from 500 to 1100° C., preferably from 500 to 850° C.

For the purposes of the present invention, calcination is heating in an oxidative gas atmosphere, e.g. a gas atmosphere comprising oxygen and otherwise inert constituents. The preferred gas atmosphere is air.

The active component (A) is preferably applied to the shaped bodies after removal of the pore-forming material. This is achieved by customary methods, e.g. by spraying it (e.g. perrhenic acid or ammonium perrhenate), if appropriate as a solution in a solvent, onto the shaped body, e.g. in a spraying drum, and firstly freeing the support which has been pretreated in this way of the solvent at a temperature of from 50 to 200° C. and subsequently calcining it at a temperature of from 500 to 1100° C., preferably from 500 to 850° C.

The third method of producing the catalyst of the invention comprises
a2) in step (a2), preparing a suspension which can be processed in a pan mill and in which a customary suspension medium forms the continuous phase and a support (S) having a maximum of the distribution function of the pore diameters in the mesopore range at from 0.002 to 0.008 μm is present in the discontinuous phase and, if appropriate, the active component (A) and customary auxiliaries are dissolved or suspended in the continuous phase,
b2) in step (b2), treating this suspension in a pan mill until the fine surface structure of the support (S) suspended therein has been altered to such an extent that shaped bodies produced from the suspension have, after drying, a maximum of the distribution function of the pore diameters in the mesopore range at from 0.008 to 0.050 μm.

The treatment time in step (b2) depends on a number of parameters, including the degree of fill of the pan mill and the treatment time. Basically, an increasing treatment time results in the maximum of the distribution function of the pore diameters in the mesopore range being shifted to higher values. The appropriate treatment time can therefore easily be determined by means of a few quick tests or by examination of samples.

After step (b2), shaped bodies are produced from the suspension by means of customary methods, e.g. by extrusion, and the active component (A) is applied to these by one of the above-described methods. The catalyst precursor obtained in this way is dried and then calcined.

The supported catalysts of the invention are particularly useful for preparing a compound having a nonaromatic C-C double bond or C-C triple bond (compound A) from another compound or mixture of other compounds having a nonaromatic C-C double bond or C-C triple bond (compound B), which comprises bringing the compound (B) into contact with a supported catalyst according to the invention at a temperature of from 50 to 500° C.

Such processes are generally known and are described, for example, in “Industrielle Organische Chemie”, Klaus Weissermel, Hans-Jurgen Erpel, 5th Edition, Verlag Wiley, VCH, 1998, Chapter 3.4, and “Handbook of Heterogeneous Catalysis”, edited by G. Ertl, H. Knözinger and J. Weitkamp, Volume 5, VCH Verlagsgesellschaft mbH, Weinheim, Chapter 4.12.2, Alkene Metathesis, pages 2387 to 2399. However, they can also be used for the metathesis of unsaturated esters, nitrites, ketones, aldehydes, acids or ethers, as described, for example, in Xiaoding, X., Imhoff, P., von den Aardweg, C. N., and Mol, J. C., J. Chem. Soc., Chem. Comm. (1985), p. 273. In the reaction of substituted olefins, a cocatalyst, for example a tin alkyl, lead alkyl or aluminum alkyl, is preferably used to achieve an additional increase in the activity.

Here, the supported catalysts of the invention can be used in the same way as the known metathesis catalysts.

The catalysts of the invention can be particularly advantageously used in metathesis processes for preparing propene by metathesis of a mixture comprising 2-butene and ethylene or 1-butene and 2-butenes, or for preparing 3-hexene and ethylene by metathesis of 1-butene. Appropriate processes are described in detail in DE-A-19813720, EP-A-1134271, WO 02/083609, DE-A-10143160.

The abovementioned C₄ starting compounds are usually supplied in the form of a raffinate II. The term raffinate II refers to C₄ fractions which generally have a butene content of from 30 to 100% by weight, preferably from 40 to 98% by weight. Apart from butenes, saturated C₄-alkanes, in particular, can also be present. The way in which such raffinates II are obtained is generally known and is described, for example, in EP-A-1134271.

In particular, it is possible to use 1-butene-comprising olefin mixtures or 1-butene which is obtained by distilling off a 1-butene-rich fraction from raffinate II. 1-Butene can likewise be obtained from the remaining 2-butene-rich fraction by subjecting the 2-butene-rich fraction to an isomerization reaction and subsequently fractionally distilling the product to give a 1-butene-rich fraction and a 2-butene-rich fraction. This process is described in DE-A-10311139.

The rhenium-containing catalysts of the invention are particularly useful for reactions in the liquid phase at temperatures of from 10 to 150° C. and a pressure of from 5 to 100 bar.

Experimental Part

### EXAMPLE 1

### Production of a Catalyst According to the Invention (A-84616)

1 kg of aluminum oxide powder (BASF D10-10, 80.6% Al₂O₃) was mixed with 30 g of 85% strength formic acid and 712 g of water in a kneader. 15 minutes before the end of the kneading time (6 h), 50 g of Walocel (methylcellulose having a mean molecular weight of 10 000 from Wolff Walsrode AG, D-29655 Walsrode) were added as pore-forming material. The mass was subsequently processed on an extruder to form 1.5 mm extrudates and dried at 120° C. for 5 hours. The extrudates were then heated in air to 720° C. over a period of 3 hours and to 750° C. over a further period of 15 minutes. This temperature was maintained for 3 hours. The intermediates produced in this way have a surface area of 172 m²/g, a water absorption of 0.83 ml/g and a porosity (Hg porosimetry) of 0.76 ml/g. 730 g of the precursor were impregnated by spraying 107 g of perrhenic acid (70.4% Re), made up with water to 0.545 I, in an impregnation drum. After being allowed to stand for 5 hours, the catalyst was firstly dried at 120° C. for 6 hours, subsequently heated to 520° C. over a period of 2 hours and to 550° C. over a further period of 15 minutes and calcined in air at this temperature for 2 hours. The finished catalyst comprised 9.8% of Re₂O₇ and had a water absorption of 0.76 ml/g.

The cumulative total surface area of the pores determined by means of Hg porosimetry in the measurement range from 300 to 0.003 μm is 152 m²/g. The pore volume was 0.69 ml/g. The maximum in the pore distribution in the mesopore range was at 9.6 nm.

### EXAMPLE 2

### Production of a Comparative Catalyst (B-84911)

5.1 kg of commercial 1.5 mm Al₂O₃ support extrudates (BASF D10-10 S1.5, BET 200 m²/g, water absorption 0.77 ml/g, porosity (Hg porosimetry) 0.61 m/g) whose raw material had been prepared by a conventional process by means of acid digestion of an aluminum hydroxide with subsequent spray calcination were impregnated by spraying 781 g of perrhenic acid (70.4% Re), made up with water to 3.473 l, in an impregnation drum. After being allowed to stand for 3 hours, the catalyst was firstly dried at 120° C. for 6 hours, subsequently heated to 520° C. over a period of 2 hours and to 550° C. over a further period of 15 minutes and calcined in air at this temperature for 2 hours. The finished catalyst comprised 9.8% of Re₂O₇ and had a water absorption of 0.66 ml/g.

The cumulative total surface area of the pores determined by means of Hg porosimetry in the measurement range from 300 to 0.003 μm was 173 m²/g. The pore volume was 0.58 ml/g. The maximum in the pore distribution in the mesopore range is at 6.5 nm.

### EXAMPLE 3

### Production of a Catalyst According to the Invention (C-85277)

6.4 kg of an aluminum oxide powder (BASF D10-10) were mixed with 195.1 g of formic acid and 2.4 l of water in a pan mill. After 50 minutes, 0.032 l of 25% strength ammonia and 300 ml of water were added. 15 minutes before the end of the kneading time, 320 g of Walocel (methylcellulose having a mean molecular weight of 10 000 from Wolff Walsrode AG, D-29655 Walsrode) were added as pore-forming material. The total kneading time was 2 hours. The mass was subsequently processed on an extruder to form 1.5 mm extrudates and dried in air at 120° C. for 16 hours. The shaped bodies were then brought to 670° C. over a period of 3 hours and to 700° C. over a further period of 15 minutes and calcined in air under these conditions for 2 hours. The intermediates produced in this way have a surface area of 185 m²/g, a water absorption of 0.69 ml/g and a porosity (Hg porosimetry) of 0.57 ml/g. 318 g of the intermediate were impregnated with aqueous perrhenic acid by spraying. After being allowed to stand for 5 hours, the catalyst was firstly dried at 120° C. for 6 hours, subsequently heated to 520° C. over a period of 2 hours and to 550° C. over a further period of 15 minutes and calcined in air at this temperature for 2 hours. The finished catalyst comprised 9.9% of Re₂O₇ and had a water absorption of 0.62 ml/g.

The cumulative total surface area of the pores determined by means of Hg porosimetry in the measurement range from 300 to 0.003 μm was 155 m²/g. The pore volume was 0.51 ml/g. The maximum of the pore distribution in the mesopore range was at 8.9 nm.

### EXAMPLE 4

### Production of a Catalyst According to the Invention (D-85403)

1.5 mm catalyst extrudates (BASF D10-10) were produced by the same conventional process described in Example 2. However, in the production of the mass for shaping, the pan milling time was increased by 65% and the pan mill batches were made 6% smaller. Otherwise, the procedure was as in Example 2. The finished catalyst comprised 9.5% of Re₂O₇ and had a water absorption of 0.61 ml/g.

The cumulative total surface area of the pores determined by means of Hg porosimetry in the measurement range from 300 to 0.003 μm is 185 m²/g. The pore volume was 0.51 ml/g. The maximum of the pore distribution in the mesopore range was at 8.0 nm.

### EXAMPLE 5

### Production of a Catalyst According to the Invention (E-85534)

As supports, use was made of 220 g of 1 mm Al₂O₃ spheres (Alumina Spheres 1/160) from Sasol (Sasol Germany GmbH, Hamburg) which have been produced by a special process starting from aluminum alkoxides, which firstly makes higher purities possible and secondly makes it possible to produce specific pore structures. The support was impregnated with perrhenic acid as in the preceding examples, dried and calcined. The finished catalyst comprised 9.4% of Re₂O₇.

The cumulative total surface area of the pores determined by means of Hg porosimetry in the measurement range from 300 to 0.003 μm was 166 m²/g. The pore volume was 0.42 ml/g. The maximum of the pore distribution in the mesopore range was at 9.2 nm.

### EXAMPLE 6

### Production of a Catalyst According to the Invention (F-85850)

As supports, use was made of 2.4 kg of the BASF product D10-21 in the form of 1.5 mm extrudates. The starting material for the supports was, as in Example 5, prepared by a special process starting from aluminum alkoxides. The support was impregnated with perrhenic acid as in the preceding examples, dried and calcined. The finished catalyst comprised 8.9% of Re₂O₇.

The cumulative total surface area of the pores determined by means of Hg porosimetry in the measurement range from 300 to 0.003 μm is 158 m²/g. The pore volume was 0.52 ml/g. The maximum of the pore distribution in the mesopore range was at 9.9 nm.

### EXAMPLE 7

### Production of a Comparative Catalyst (G-85869)

A catalyst was produced by a method analogous to Example 2. The catalyst comprised 9.1% by weight of Re₂O₇.

The cumulative total surface area of the pores determined by means of Hg porosimetry in the measurement range from 300 to 0.003 μm was 167 m²/g. The pore volume was 0.50 ml/g. The maximum of the pore distribution in the mesopore range was at 7.0 nm.

### EXAMPLE 8

### Production of a Catalyst According to the Invention (H-85893)

A catalyst was produced by a method analogous to Example 5, but a material from Sasol, “Al₂O₃ extrudates, 1.5/150 Z600100”, in the form of 1.5 mm extrudates is used as support. The catalyst comprised 9.5% by weight of Re₂O₇.

The cumulative total surface area of the pores determined by means of Hg porosimetry in the measurement range from 300 to 0.003 μm was 136 m²/g. The pore volume was 0.75 ml/g. The maximum of the pore distribution in the mesopore range was at 21.0 nm.

### EXAMPLES A-H

### Measurement of the Catalyst Activity

10-15 g of catalyst were in each case installed in a tube reactor. The feed consisted of 150-200 g/h of a mixture of about 85-90% of linear butenes, about 2.5% of isobutene and butanes as balance (raffinate II). Since the composition of the feed can fluctuate greatly, especially in respect of contamination with dienes which severely poison the catalyst and thus lead to rapid deactivation, only measurements which were carried out using the same batch of raffinate 11 can be compared with one another. The tables under (i), (ii) and (iii) in each case relate to two different batches of raffinate 11. The reaction conditions are 40° C. and 35 bar in each case. The composition of the stream leaving the reactor was monitored by means of on-line GC. As representatives of the numerous components, the amounts of the most important or major products, i.e. propene, trans-2-pentene and trans-3-hexene at different measurement times have been shown in the table below. All products not shown (ethylene, cis-2-pentene, cis-3-hexene, 2-methyl-2-butene and 2-methyl-2-pentene) in principle display similar changes over time and comparable differences at relatively low running times. A repeat measurement carried out on Example C shows that the measured differences between catalysts according to the invention and comparative examples are significantly greater than the measurement inaccuracies.

| | i) | | | | | |
|---|---|---|---|---|---|---|
| | 84616 (according to the inv.) - Ex. A | | | 84911 (comp.) - Ex. B1 | | |
| | | trans-2- | trans-3- | | trans-2- | trans-3- |
| t | Propene | Pentene | Hexene | Propene | Pentene | Hexene |
| [h] | [% by weight] | [% by weight] | [% by weight] | [% by weight] | [% by weight] | [% by weight] |
| 4 | 14.3 | 14.1 | 2.8 | 12.6 | 12.6 | 2.3 |
| 9 | 12.1 | 11.0 | 1.7 | 9.0 | 9.1 | 1.2 |
| 17 | 7.7 | 7.8 | 0.8 | 6.3 | 6.5 | 0.6 |
| 26 | 6.8 ^{(-52%)} | 6.9 ^{(-51%)} | 0.7 ^{(-75%)} | 4.9 ^{(-61%)} | 5.1 ^{(-60%)} | 0.4 ^{(-83%)} |
| | ii) | | | | | |
| | | | | Repeat of 85277 (according to the inv.) - | | |
| | 85277 (according to the inv.) - Ex. C1 | | | Ex. C2 | | |
| | | trans-2- | trans-3- | | trans-2- | trans-3- |
| T | Propene | Pentene | Hexene | Propene | Pentene | Hexene |
| [h] | [% by weight] | [% by weight] | [% by weight] | [% by weight] | [% by weight] | [% by weight] |
| 4 | 17.4 | 16.5 | 4.8 | 17.6 | 16.9 | 5.1 |
| 9 | 16.6 | 15.5 | 4.2 | 17.1 | 16.4 | 4.8 |
| 17 | 15.2 ^{(-13%)} | 14.3 ^{(-13%)} | 3.5 ^{(-27%)} | 16.7 ^{(-5%)} | 15.7 ^{(-7%)} | 4.3 ^{(-16%)} |
| | 85403 (according to the inv.) - Ex. D | | | 84911 (comp.) - Ex. B2 | | |
| | | trans-2- | trans-3- | | trans-2- | trans-3- |
| t | Propene | Pentene | Hexene | Propene | Pentene | Hexene |
| [h] | [% by weight] | [% by weight] | [% by weight] | [% by weight] | [% by weight] | [% by weight] |
| 4 | 17.3 | 16.4 | 4.8 | 17.0 | 16.5 | 4.9 |
| 9 | 16.1 | 15.1 | 3.9 | 14.6 | 14.1 | 3.4 |
| 17 | 13.3 ^{(-23%)} | 12.7 ^{(-23%)} | 2.7 ^{(-44%)} | 11.8 ^{(-31%)} | 11.6 ^{(-30%)} | 2.3 ^{(-53%)} |
| | 85534 (according to the inv.) - Ex. E | | | 85850 (according to the inv.) - Ex. F | | |
| | | trans-2- | trans-3- | | trans-2- | trans-3- |
| t | Propene | Pentene | Hexene | Propene | Pentene | Hexene |
| [h] | [% by weight] | [% by weight] | [% by weight] | [% by weight] | [% by weight] | [% by weight] |
| 4 | 15.7 | 18.6 | 7.9 | 16.8 | 18.5 | 5.3 |
| 9 | 15.6 | 18.7 | 7.8 | 16.2 | 17.7 | 4.8 |
| 17 | 15.7 *⁾ | 18.7 *⁾ | 7.8 *⁾ | 15.6 ^{(-7%)} | 16.9 ^{(-9%)} | 4.6 ^{(-13%)} |
| | iii) | | | | | |
| | 85869 (comp.) - Ex. G | | | 85893 (according to the inv.) - Ex. H | | |
| | | trans-2- | trans-3- | | trans-2- | trans-3- |
| t | Propene | Pentene | Hexene | Propene | Pentene | Hexene |
| [h] | [% by weight] | [% by weight] | [% by weight] | [% by weight] | [% by weight] | [% by weight] |
| 4 | 16.1 | 16.3 | 4.4 | 16.8 | 18.1 | 4.9 |
| 9 | 13.4 | 13.2 | 4.1 | 15.8 | 16.7 | 3.9 |
| 17 | 10.4 ^{(-35%)} | 10.9 ^{(-33%)} | 2.0 ^{(-55%)} | 13.7 ^{(-18%)} | 13.7 ^{(-24%)} | 2.4 ^{(-51%)} |

*⁾ No deactivation could be detected within the monitored period of time.

It can be seen that the catalysts of the invention display an overall slower rate of deactivation and sometimes also display higher initial activities, so that more products are present in the exit stream after a prolonged running time, which significantly increases the table yield.

1. A supported catalyst comprising a support (S) in which Al₂O₃ is present in a proportion of at least 75% by weight and rhenium compounds as active component (A), wherein the maximum of the distribution function of the pore diameters in the mesopore range is from 0.008 to 0.050 μm.

2. The supported catalyst according to claim 1, wherein the support (S) comprises Al₂O₃ together with compounds selected from the group consisting of SiO₂, aluminosilicates, TiO₂, ZrO₂, MgO, CeO₂ and ZnO.

3. The supported catalyst according to claim 1, wherein the active component (A) comprises rhenium oxide together with a promoter selected from the group consisting of phosphorus oxide, Fe₂O₃, tantalum oxide, ZrO₂, SiO₂, niobium oxide, oxides of the elements of the lanthanide series, vanadium oxide, molybdenum, tungsten, alkali metal, alkaline earth metal and tin compounds.

4. The supported catalyst according to any of claim 1, wherein the amount of rhenium compound is selected so that the supported catalyst comprises from 0.01 to 1 mmol of rhenium per gram of supported catalyst.

5. A process for producing a supported catalyst according to claim 1, which comprises
a1) in step (a1), producing a raw mixture (a) comprising the support (S) onto which the active component (A) may have been applied if appropriate, a pore-forming material (P), optionally auxiliaries and optionally an active component,
b1) in step (b1), forming shaped bodies for supported catalysts from the raw mixture (a) and, either simultaneously or in a subsequent separate procedure, removing the pore-forming material (P) by heating,
c1) in step (c1), optionally applying the active component (A) to the shaped bodies, with the step (c1) being obligatory if the production of the raw mixture (a) in step (a1) has been carried out without using the active component (A) or a support (S) to which an active component (A) has already been applied and otherwise being optional.

6. The process according to claim 5, wherein the pore-forming material (P) is selected from the group consisting of tartaric acid, oxalic acid, citric acid, ammonium nitrate, ammonium oxalate, guanidinium salts, urotropin, protein, carbohydrate polytetrahydrofuran, surfactants, sulfonic acids, polyvinyl alcohol, methylcellulose, polyalcohols, lactic acid, polyethylene oxides, polymethylene oxides, polypropylene oxides, polyolefins, nut shell powders, polyacrylates, carbonates, hydrogencarbonates, fats, waxes, fatty acids, alginates, textile fibers, plant fibers and oxalates.

7. The process according to claim 5, wherein the raw mixture (a) is prepared as a powdered mixture and the shaped bodies are produced by pressing the powder mixture.

8. The process according to any of claim 5, wherein the raw mixture (a) is prepared as an extrudable suspension in which the support (S) and the pore former (P) form a discontinuous phase and a customary suspension medium forms the continuous phase and the active component (A), if present, is dissolved or suspended in the continuous phase.

9. The process according to any of claim 5, wherein the raw mixture (a) prepared as an extrudable suspension in step (a) is converted in step (b) into a moldable supported catalyst precursor by shaping the extrudable suspension to form shaped bodies for supported catalysts and subsequently curing the shaped bodies by evaporating the suspension medium.

10. A process for producing the supported catalyst according to claim 1, which comprises producing the supported catalyst by customary methods from a support (S) having a maximum of the distribution function of the pore diameters in the mesopore range at from 0.008 to 0.050 μm and an active component (A) using auxiliaries if appropriate.

11 . The process according to claim 10, wherein the support (S) having a maximum of the distribution function of the pore diameters in the mesopore range at from 0.008 to 0.050 μm is produced by aging an aluminum alkoxide at a water vapor pressure of from 1 to 30 bar and a temperature of from 100 to 235° C., for from 0.5 to 20 hours while stirring at a circumferential velocity of from 1.0 to 6.0 m/s and drying and if appropriate shaping the resulting synthetic aluminum hydroxide.

12. The process according to claim 11, wherein supports (S) having a maximum of the distribution function of the pore diameters in the mesopore range at from 0.008 to 0.050 μm are produced by
preparing an alumina sol from a synthetic aluminum hydroxide prepared according to claim 11 by suspending the alumina hydrate in dilute mineral acid having a concentration of from 1 to 5% and subsequently adding from 1 to 10% by weight, based on the total weight of the sol, of urea,
introducing the alumina sol dropwise into a shaping column whose lower part is filled with aqueous ammonia solution, and
drying the spherical particles formed in the shaping column.

13. A process for producing the supported catalyst according to claim 1, which comprises
a2) in step (a2), preparing a suspension which can be processed in a pan mill and in which a suspension medium forms the continuous phase and a support (S) having a maximum of the distribution function of the pore diameters in the mesopore range at from 0.002 to 0.008 μm is present in the discontinuous phase and optionally the active component (A) and customary auxiliaries are dissolved or suspended in the continuous phase,
b2) in step (b2), treating this suspension in a pan mill until the fine surface structure of the support (S) suspended therein has been altered to such an extent that shaped bodies produced from the suspension have, after drying, a maximum of the distribution function of the pore diameters in the mesopore range at from 0.008 to 0.050 μm.

14. A process for preparing a compound having a nonaromatic C—C double bond or C—C triple bond (compound A) from another compound or mixture of other compounds having a nonaromatic C—C double bond or C—C triple bond (compound B), which comprises bringing the compound (B) into contact with a supported catalyst according to any of claim 1 at a temperature of from 50 to 500° C.

15. The process according to claim 14, wherein compound (B) is 1-butene or a mixture of butenes comprising 1-butene.

16. The process according to claim 5, wherein the pore-forming material (P) is selected from the group consisting of tartaric acid, oxalic acid, citric acid, ammonium nitrate, ammonium oxalate, guanidinium salts, urotropin, gelatin, glucose, sucrose, soluble starch, polytetrahydrofuran, surfactants, sulfonic acids, polyvinyl alcohol, methylcellulose, polyalcohols, lactic acid, polyethylene oxides, polymethylene oxides, polypropylene oxides, polyolefins, nut shell powders, polyacrylates, carbonates, hydrogencarbonates, fats, waxes, fatty acids, alginates, textile fibers, plant fibers and oxalates.
